(19) United States
(12) Patent Application Publication
(10) Pub. No.: US 2016/0168515 A1
(43) Pub. Date: Jun. 16, 2016

(54) MANGANESE CARBOXYLATES FOR PEROXYGEN ACTIVATION

(71) Applicants: Michael B. Abrams, Bala Cynwyd, PA (US); Cecile N. BONNET, Philadelphia, PA (US); ARKEMA INC., King of Prussia, PA (US)

(72) Inventors: Michael B. ABRAMS, Bala Cynwyd, PA (US); Cecile N. Bonnet, Philadelphia, PA (US)

(21) Appl. No.: 14/906,973

(22) PCT Filed: Nov. 15, 2013
(86) PCT No.: PCT/US13/70269

§ 371 Date: Jan. 22, 2016

Related U.S. Application Data
(60) Provisional application No. 61/857,815, filed on Jul. 24, 2013.

(51) Int. Cl. C11D 3/39

(52) U.S. Cl. CPC C11D 3/3932

(57) ABSTRACT

The efficacy of peroxy compounds such as hydrogen peroxide in bleaching compositions and the like may be enhanced by the presence of manganese carboxylates containing branched chain carboxylate and/or tartrate groups. The invention relates to the activation of peroxy compounds using particular types of manganese carboxylates so as to render such compounds more effective in bleaching stains from substrate surfaces and other such applications.

### FIELD OF THE INVENTION

The invention relates to the activation of peroxy compounds using particular types of manganese carboxylates so as to render such compounds more effective in bleaching stains from substrate surfaces and other such applications.

### BACKGROUND OF THE INVENTION

Materials that react beneficially with hydrogen peroxide and other peroxy compounds are needed for a wide variety of applications. For laundry detergents, for example, substances that react with hydrogen peroxide to provide improved stain bleaching (versus peroxide alone or versus alternatives) are highly desirable. Hydrogen peroxide alone does not provide sufficient bleaching on all stains of interest, often does not provide sufficient stain bleaching at low temperatures, or does not bleach quickly enough at ambient or elevated temperatures to match the performance of existing alternatives. Current organic activators for hydrogen peroxide (such as the peracid generators currently used for solid laundry detergents) typically operate stoichiometrically, providing economic challenges to practical implementation. Current commercial metal-based oxidation catalysts and activators may suffer from deficiencies in one or more of the following areas: poor bleaching (oxidative) activity, poor solubility, prohibitively expensive economics, and/or poor environmental fate profiles (e.g. toxicity). The ability to more effectively use hydrogen peroxide (whose sole degradation products are water and oxygen) could eliminate the use of potentially harmful chlorine-based bleaches (e.g., sodium hypochlorite for cleaning, chlorine dioxide for pulp and paper). Manganese (Mn) is a relatively inexpensive and nontoxic metal; a peroxy compound activation catalyst employing manganese could provide significant economic and health/environment/safety advantages compared to current existing alternatives.

### SUMMARY OF THE INVENTION

This invention pertains to the use of metal-carboxylate-containing materials as peroxy compound (e.g., hydrogen peroxide) activators; that is to say that the metal-containing complex reacts with hydrogen peroxide or another peroxy compound to provide a species that provides superior oxidation performance (e.g., stain bleaching or pulp bleaching). The activators are manganese carboxylates based on branched chain carboxylate or tartrate.

In one aspect of the invention, a composition is provided which is comprised of at least one peroxy compound and an amount of at least one manganese carboxylate activator effective to activate the peroxy compound, wherein the manganese carboxylate activator is comprised of manganese and at least one carboxylate group selected from the group consisting of branched chain carboxylate groups, tartrate, and combinations thereof.

Another embodiment of the invention furnishes a method of making a composition, comprising combining at least one peroxy compound and an amount of at least one manganese carboxylate activator effective to activate the peroxy compound, wherein the manganese carboxylate activator is comprised of manganese and at least one carboxylate group selected from the group consisting of branched chain carboxylate groups, tartrate, and combinations thereof.

A method of bleaching a substrate is provided in another inventive embodiment, wherein the method comprises contacting the substrate with a bleaching composition comprised of at least one peroxy compound and an amount of at least one manganese carboxylate activator effective to activate the peroxy compound, wherein the manganese carboxylate activator is comprised of manganese and at least one carboxylate group selected from the group consisting of branched chain carboxylate groups, tartrate, and combinations thereof.

The invention also provides, in a further aspect, a method for cleaning or bleaching of a substrate (e.g., fabric, paper, pulp or hard surface) which comprises contacting the substrate with a peroxy compound present in an effective amount to accomplish a desired level of bleaching or cleaning and an activator present in an effective amount to activate the peroxy compound, wherein the activator is a manganese carboxylate comprised of manganese and at least one carboxylate group selected from the group consisting of branched chain carboxylate groups, tartrate, and combinations thereof.

In still another aspect of the invention, a method of activating a peroxy compound is provided, comprising combining the peroxy compound with at least one manganese carboxylate activator, wherein the manganese carboxylate activator is comprised of manganese and at least one carboxylate group selected from the group consisting of branched chain carboxylate groups, tartrate, and combinations thereof.

### DETAILED DESCRIPTION OF THE INVENTION

The present invention relates to the use of certain types of manganese carboxylates as peroxy compound activators. Without wishing to be bound by theory, it is believed that the carboxylate complexes of manganese react with peroxy compounds such as hydrogen peroxide to form species that provide superior oxidation performance in stain bleaching, pulp bleaching or the like as compared to the use of peroxy compound in the absence of the metal carboxylate activator.

Manganese carboxylates useful as activators for peroxy compounds in accordance with the present invention include compounds which contain at least one manganese center and at least one carboxylate group bound to, or otherwise associated with, manganese. The manganese may, for example, be in the +2 oxidation state (i.e., Mn(II)) and/or in the +3 oxidation state (i.e., Mn(III)) and/or in other oxidation states (e.g., Mn(IV), Mn(V)). Thus, the manganese may be present in a single oxidation state or in two or more oxidation states. The manganese carboxylate may contain one or two carboxylate groups. Stoichiometric as well as non-stoichiometric manganese carboxylates may be utilized. For example, the activator may have two Mn centers and only one carboxylate group. Where more than one carboxylate group is present, the carboxylate groups may be the same as or different from each other. In addition to the carboxylate group(s), the manganese carboxylate may contain one or more non-carboxylate groups as ligands, coordinating species, counterions or the like. For example, the manganese carboxylate may comprise, in addition to tartrate and/or branched carboxylate and manganese, one or more species selected from H₂O, alcohols (ROH), ethers (ROR), amines (NR₃), phosphines (PR₃), cyano-functionalized compounds (RCN), HO⁻, HS⁻, HOO⁻, alkoxides (RO⁻), carboxylates other than branched chain carboxylate and tartrate (RCOO⁻), F₃CSO₂⁻, BE₄⁻, BPh₄⁻, PF₆⁻, ClO₄⁻, OCN⁻, SCN⁻, NR₂⁻, N₃⁻, CN⁻, F⁻, Cl⁻, Br⁻, I⁻, H⁻, R⁻, O₂⁻, O²⁻, NO₃⁻, NO₂⁻, SO₄²⁻, RSO₃⁻, SO₃²⁻, RBO₂²⁻, PO₄³⁻, H⁺, Li⁺, Na⁺, Me²⁺, Ca²⁺, cyclopentadienyl and substituted cyclopentadienyl, carbonyl, organic phosphates, organic phosphonates, organic sulfates, organic sulfonates, and substituted or unsubstituted aromatic N donors such as pyridines, bipyridines, terpyridines, pyrazines, pyrazoles, imidazoles, benzimidazoles, pyrimidines, triazoles, and thiazole.

The carboxylate group(s) may be selected from tartrate and branched carboxylate groups. Suitable branched carboxylate groups include, but are not limited to, C3-C12 branched chain carboxylate groups as well as C6-C10 branched chain carboxylate groups. The branched chain carboxylate group may contain one, two or more branching sites. In one embodiment, the branched chain carboxylate group is non-cyclic. In another embodiment, however, the branched chain carboxylate group is alicyclic, i.e., it contains one or more cyclic aliphatic groups such as cyclopentane or cyclohexane. An alicyclic branched chain carboxylate group may contain non-cyclic segments, in addition to the cyclic aliphatic group. For example, the alicyclic branched chain carboxylate group may correspond to the general formula Cyc-(CH₂)ₙ—C(═O)—O—, wherein Cyc is a cyclic aliphatic group and n is 0 or an integer of 1 to 6. The branched chain carboxylate group may be a hydrocarbyl group (i.e., contain only carbon and hydrogen, in addition to the oxygen atoms comprising the carboxyl functionality) or may contain one or more heteroatoms (in addition to the oxygen atoms comprising the carboxyl functionality) such as oxygen, sulfur, nitrogen, halogen and the like.

Suitable illustrative carboxylate groups include, but are not limited to, 2-ethylbutanoate, 2-methylpentanoate, 4-methylpentanoate, 2,2,3-trimethylbutanoate, 2,2-dimethylpentanoate, 2-methyl-hexanoate, 2-ethyl-4-methylpentanoate, 2-ethylhexanoate, 2,2,4,4-tetramethylpentanoate, 2-propyl-4-methylpentanoate, 3,5,5-trimethylhexanoate, 4-ethyl-5-methylhexanoate, 4-ethyl-5,5-dimethylhexanoate, 4-ethyl-5-methylheptanoate, 2-propylheptanoate, cyclohexanecarboxylate, cyclohexaneacetate, cyclohexanepropionate, cyclohexanebutyrate, cyclohexanepentoate, cyclohexanehexanoate and combinations thereof.

Illustrative examples of suitable manganese carboxylate activators useful in the present invention include manganese tartrate, manganese bis(2-ethylhexanoate), manganese 2-ethylhexanoate salt, and manganese bis(cyclohexanebutyrate).

The manganese carboxylate activators useful in the present invention may be made by any suitable method, including the methods known in the art for preparing carboxylates of manganese. The manganese carboxylate may be preformed and then combined with one or more other components (including one or more peroxy compounds) to provide a cleaning, bleaching or other composition in accordance with the invention. In one embodiment, the manganese carboxylate is formed in situ in the composition from precursors such as a carboxylic acid or salt thereof and a source of manganese (e.g., a non-carboxylate containing manganese compound, especially Mn(II) and Mn(III) salts such as MnCl₂, Mn(NO₃)₂, Mn₃(PO₄)₂, and manganese sulfate. For example, a carboxylate ligand or precursor thereto may be introduced in a wash liquor intended for use in cleaning or bleaching a textile and the activator generated in situ through complexation or reaction of the ligand(s) with manganese ions occurring naturally in the water used to make up the wash liquor. In another embodiment, a carboxylate ligand or precursor thereto and a source of manganese may be maintained in separate chambers or enclosures and then dispensed together into a wash liquor or the like, whereby they then interact to form the manganese carboxylate activator.

The manganese carboxylate may be present in a composition (e.g., a detergent composition) in an amount effective to promote the bleaching action of the peroxy compound. The activator may function in a catalytic or a non-catalytic manner, in different embodiments of the invention. In one aspect of the invention, compositions may be formulated to contain manganese carboxylate activator in an amount of from about 0.1 ppm to about 100 ppm or an amount of from about 0.5 to about 10 ppm, when the composition is being employed for its intended use such as bleaching or cleaning a substrate surface such as a fabric which is stained or otherwise soiled.

Useful peroxy compounds in the context of the present invention include hydrogen peroxide, hydrogen-peroxide liberating compounds (e.g., hydrogen peroxide precursors), urea peroxide, organic peroxides, organic hydroperoxides, alkali metal peroxides, perborates such as alkali metal perborates (e.g., sodium perborate), percarbonates such as alkali metal percarbonates (e.g., sodium percarbonate), perphosphates, persulphates, peroxyacids and their salts, O₂ and the like and combinations thereof. The peroxy compound may, for example, be selected from the group consisting of water-soluble inorganic persalts which yield hydrogen peroxide when dissolved in water. In one embodiment of the invention, the amount of peroxy compound in a composition to be used for cleaning and/or bleaching purposes may be selected such that between about 10 ppm and 10% active oxygen (e.g., from about 50 to about 5000 ppm of active oxygen) is present in the composition.

The compositions of the present invention are particularly useful for cleaning products (e.g., bleaching, stain removal), and especially useful for laundry detergents, auxiliary bleaches, dishwashing detergents, hard surface cleaners, carpet cleaners, and the like. The substrate may be in any form, including, for example, in solution or in solid form (thereby having at least one surface, wherein the substrate surface is bleached or cleaned as a result of being contacted with the inventive compositions described herein).

As used herein detergent compositions include articles and cleaning and treatment compositions. As used herein, the term “cleaning and/or treatment composition” includes, unless otherwise indicated, tablet, granular or powder-form all purpose or “heavy-duty” washing agents, especially laundry detergents; liquid, gel or paste-form, or supported or adsorbed on woven or non-woven fibers, all-purpose washing agents, especially the so-called heavy-duty liquid types; liquid fine-fabric detergents; hand dishwashing agents or light duty dishwashing agents, especially those of the high-foaming type; and machine dishwashing agents, including the various tablet, granular, liquid, and rinse-aid types for household and institutional use. The compositions can also be in containers with multiple reservoirs or in unit dose packages, including those known in the art and those that are water soluble, water insoluble, and/or water permeable.

Suitable detergent ingredients include, but are not limited to, surfactants (including nonionic, anionic, cationic and zwitterionic surfactants), builders, chelating agents, dye transfer inhibiting agents, dispersants, enzymes, enzyme stabilizers, bleach activators (in addition to the manganese carboxylate), polymeric dispensing agents, brighteners, suds suppressors, dyes, anti-corrosion agents, tarnish inhibitors, perfumes, fabric softeners, carriers, hydrotropes, processing aids, solvents (including water), colorants, fragrances, abrasives, thickeners, fluorescent dyes, coupling agents, and/or pigments.

A detergent composition in accordance with the present invention may be formulated as free-flowing particles, e.g., in powdered or granular form, and can be produced by any of the conventional techniques employed in the manufacture of detergent compositions, for example by slurry-making and spray-drying processes to form a detergent base powder to which heat-sensitive ingredients, such as the peroxy compound(s) and optionally other ingredients as desired, as well as the manganese carboxylate activator, can be added as dry substances. The dry particles can be admixed with water to form a wash liquid, which is then brought into contact with a substrate for a period of time and at a temperature effective to achieve the desired level of cleaning and/or bleaching or oxidation of the substrate. In an alternative embodiment, a liquid solution of the manganese carboxylate activator can be added separately to a wash/bleach liquid (e.g., an aqueous wash/bleach liquid) containing the peroxy compound (which is capable of acting as a bleaching agent or otherwise assisting in the cleaning or bleaching of the substrate being contacted with the wash/bleach liquid). In yet another embodiment, a liquid solution of the manganese carboxylate activator and a liquid solution of the peroxy compound may be segregated during storage in separate chambers or enclosures (in a dispensing device, for example) such that the manganese carboxylate activator and peroxy compound are kept separated. When the oxidation of a substrate such as a substrate surface is desired to be carried out, the two liquid solutions may then be combined to form a wash liquor or the like which is then contacted with the substrate. In this way, premature degradation of the peroxy compound caused by the manganese carboxylate activator may be reduced or eliminated.

One potential method for delivering a manganese carboxylate activator to a wash liquid for cleaning would be to have a preformed activator (or activator precursor) be a part of a laundry detergent formulation, with the full formulation added to the wash. Alternately, a preformed manganese carboxylate activator could be adsorbed or supported on a woven or non-woven sheet and added to the wash in conjunction with a detergent formulation; alternately, detergent formulation ingredients could be adsorbed or supported on the sheet along with the activator, precluding the need for both sheet and detergent addition to the wash.

Also within the scope of this invention is use of more than one activator to promote cleaning or oxidation. Mixtures of two or more manganese carboxylates may be used, as may mixtures of manganese carboxylates and metal activators not containing manganese and/or not containing carboxylate ligands, as may mixtures of manganese carboxylates with organic activators (such as N,N,N′,N′-tetraacetylethylenediamine (TAED) or sodium nonanoyloxybenzenesulfonate) or bleach boosters. Thus, in one embodiment, a composition to be used for cleaning and/or bleaching may comprise, in addition to the manganese carboxylate activator and peroxy compound, one or more catalysts, activators and/or boosters other than the manganese carboxylate activators discussed herein.

Under certain conditions, peroxy compounds may exhibit instability in the presence of the manganese carboxylate activators used in the present invention. Such instability may interfere with the ability to store compositions containing both peroxy compound and manganese carboxylate for long periods of time without such compositions exhibiting an unacceptable loss of active oxygen content. Therefore, in one embodiment of the invention the manganese carboxylate and peroxy compound are stored separately and then combined to provide the desired composition shortly before such composition is to be used to bleach or clean a substrate or in accordance with any other desired use as described herein. Two part formulations thus are considered within the scope of the invention, wherein one part contains manganese carboxylate (optionally in combination with one or more additional components other than peroxy compound) and a second part contains peroxy compound (optionally in combination with one or more other components other than manganese carboxylate). In another embodiment, the composition is a one part formulation wherein the peroxy compound and manganese carboxylate are segregated in some way that prevents direct interaction until such time that the composition is to be used for its intended purpose. For example, the manganese carboxylate (or the peroxy compound) may be sequestered or encapsulated within a water-soluble substance in the form of dry particles, which dissolve or disintegrate when combined with water to release the sequestered or encapsulated component, which then becomes available for interaction (in an aqueous solution, for example) with the peroxy compound (or the manganese carboxylate, as the case may be).

The activators of the present invention can be used in applications, including, but not limited to:
Cleaning: general fabric cleaners including but not limited to liquid or solid or powdered or tablet or unit dose laundry detergents, auxiliary bleaches (solid, liquid, or paste), pre-spot treating agents, activator “sheets” (in which an activator, and possibly other benefit-providing ingredients such as surfactant, is adsorbed onto or supported on a woven- or nonwoven sheet and added to the washing machine), and general household cleaners including but not limited to automatic dishwashing detergents (powder, gel, tablet, paste, or suspension), spray or concentrated (dilutable) hard surface cleaners, toilet bowl cleaners, carpet cleaners, carpet prespotters, heavy duty cleaners, fence/deck/siding cleaners, drain cleaners, stain removers, hand dish detergents, hand detergents and specialty cleaners.
Pulp and paper: bleaching, brightening, and delignification in mechanical and chemical pulping, and deinking during paper recycling.
Personal care: antiseptic applications, hair bleaching and coloring, tooth whitening and oral care.
Chemical processes: general oxidation reactions including but not limited to epoxidation, hydroxylation, bromine reactivation, organic peroxide production, amine oxidation, processes for chemical or pharmaceutical synthesis or manufacture, as well as decolorization.
Textile or fiber bleaching.
Environmental: water treatment, wastewater or storm water treatment, including but not limited to pollutant degradation and decolorization, and wastewater or storm water odor reduction or elimination.
General broad-spectrum disinfection and sanitization, mold/mildew, spore, virus, fungus removers.
Defense: chemical or biological warfare agent degradation.
Bioethanol: improved delignification for increased cellulosic ethanol production.
Desulfurization of diesel fuel, gasoline, kerosene, biodiesel, or coal.

One aspect of the invention is directed to a method wherein conditions are created, in the presence of a substrate surface (such as a hard surface, e.g., a ceramic, stone, plastic, thermoset resin, or composite surface, or a fabric surface, e.g., a textile surface) contaminated with colored stains under which a peroxy compound (capable of acting as an oxidizing agent) and a manganese carboxylate activator in accordance with the invention can interact, with the aim of obtaining more strongly oxidizing conversion products. Such conditions are present especially when the reactants encounter one another in aqueous solution. This can be accomplished by separate addition of the peroxy compound and the manganese carboxylate to a solution, optionally containing one or more other ingredients such as surfactants and the like. Alternatively, a cleaning composition may be employed which comprises manganese carboxylate activator and optionally peroxy compound. The peroxy compound can also be added to the solution separately, either in substantially pure form or as an aqueous solution or suspension, when a peroxy compound-free cleaning composition is used.

Once the solution has been contacted with the contaminated substrate for the desired period of time (e.g., a time effective to at least partially remove or lessen the color intensity of the contaminants on the substrate), contacting the solution with the substrate may be discontinued and the substrate may be rinsed with water or the like to remove residual solution and to wash away contaminants no longer adhered to the substrate. It should be noted that the present invention is useful for removing, or lessening the color intensity of, various types of stains which may be associated with a solid substrate, regardless of whether the stain in present only on the substrate surface, has penetrated into the substrate itself, or is otherwise somehow affixed to the substrate.

While the present invention has been described with respect to particular embodiments thereof, it is apparent that numerous other forms and modifications of this invention will be evident to those skilled in the art. The appended claims and this invention generally should be construed to cover all such obvious forms and modifications which are within the true spirit and scope of the present invention.

### EXAMPLES

The following experimental procedure may be used to assess stain bleaching performance:
The optical properties of pieces of stained cotton (“sheets”, purchased from Testfabrics; West Pittston, Pa., USA) are measured on a Datacolor SF650X, incorporating a 420 nm filter to remove UV-wavelength light.
A 2-L Terg-o-tometer “well” (reactor; Instrument Marketing Services, Inc., Fairfield, N.J., USA) with vertical impeller agitation is charged with 1-L of deionized water, and the temperature of the reactor is brought to 30° C.
The well content hardness and ion ratio are adjusted through addition of aqueous Ca and Mg salts.
The reactor is then charged with detergent formulation ingredients (typically containing a combination of surfactants, builders, chelating agents, dye transfer inhibiting agents, dispersants, enzymes, enzyme stabilizers, polymeric agents, brighteners, suds suppressors, dyes, anti-corrosion agents, tarnish inhibitors, perfumes, fabric softeners, carriers, hydrotropes, processing aids, solvents, viscosity control agents, and/or pigments), and the mixture agitated for several minutes.
The pH is then adjusted by addition of aqueous sodium hydroxide or sulfuric acid.
A peroxygen source (typically hydrogen peroxide or sodium percarbonate) and the metal carboxylate (or reference activator) are then added to the reactor, and the reactor contents agitated for 1 minute.
The stained cotton sheets are then charged to the reactor, and the reactor contents agitated for 30 minutes.
The aqueous solution is discarded, and the cotton sheets rinsed in the well twice with 1-L aliquots of tap water (5 minutes of agitation for each rinse).
The stain sheets are removed from the reactor and are squeezed gently by hand in order to remove a substantial amount of water; the sheets are then laid horizontally on a rack and dried in a Whirlpool DBXR463EG5WW electric dryer for 40 minutes on Regular heat.
The stains are then ironed (medium heat; no steam), and the post-wash optical properties measured.
Cleaning performance is evaluated through an assessment of pre- and post-wash optical properties.

Cleaning experiments have been conducted using these protocols, with the following specific conditions:
Hardness=16° d
Ca:Mg=5:1
Detergent ingredients=3.8 g/L
peroxygen source=Arkema H₂O₂-EG
pH=10.5
Optical property calculation: the CIE color space values L*, a*, and b* are used to calculate E* according to Equation (1). The difference between the pre- and post-wash E* values (ΔE*) is calculated according to Equation (2). Higher values of ΔE* correspond to better cleaning. Average ΔE* (reported in the Tables below) are the average ΔE* value for three replicate experiments.

E*=\sqrt{(L*)²+(a*)²+(b*)²} (Eq. 1)

ΔE*=E*_{post-wash}−E*_{pre-wash} (Eq. 2)

Activators were purchased from commercial sources (e.g. Acros Organics, Alfa Aesar, MP Biomedicals, Strem Chemicals, Aldrich Chemicals).

The following two tables summarize cleaning data using a variety of activators under these conditions. Entries 1-6 were run using nine stain sheets per Terg-o-tometer well; Entries 7-12 were run using six stain sheets per Terg-o-tometer well. Reported, for reference, is cleaning under otherwise analogous conditions using the commercial activator N,N,N′,N′-tetraacetylethylenediamine (TAED; Entries 4 and 11), and the analogous systems without any activator (Entries 6 and 12).

TABLE 1
Cleaning experiments using nine stains per Terg-o-tometer well.

| | | | | | Average ΔE* | | | | | | | | |
|---|---|---|---|---|---|---|---|---|---|---|---|---|---|
| | | | | | | | | | | | | CS103 | |
| | | | | | | | BC3 | | 10BB | CS12 | | Wine, | CS3 |
| | | | [H2O2] | [Activator], | CN17 | BC2 | Tea, Low | EMPA167 | Black- | Black | CS15 | Single | Wine, |
| Entry | Type | Activator | ppm | mol/L | Blank | Coffee | Temperature | Tea | berry | Currant | Blueberry | Soiled | Aged |
| 1 | Carboxylate | 1 | 185 | 1.5E−04 | −0.3 | 4.1 | 9.4 | 13.5 | 21.7 | 34.1 | 34.2 | 24.1 | 18.2 |
| 2 | Carboxylate | 2 | 185 | 1.5E−04 | −0.3 | 3.8 | 8.6 | 12.6 | 21.9 | 33.5 | 33.9 | 23.7 | 17.7 |
| 3 | Carboxylate | 3 | 185 | 8.9E−5 | −0.3 | 4.1 | 9.5 | 14.1 | 21.8 | 34.1 | 34.5 | 24.7 | 18.1 |
| 4 | Reference | 5 | 185 | 5.7E−4 | −0.2 | 4.4 | 9.0 | 13.0 | 21.9 | 34.1 | 33.8 | 25.4 | 19.0 |
| 5 | Reference | None | 0 | 0 | −1.3 | −0.2 | −0.1 | 0.8 | 16.7 | 21.6 | 18.9 | 14.4 | 7.5 |
| 6 | Reference | None | 185 | 0 | −0.4 | 2.9 | 2.9 | 10.4 | 22.1 | 33.2 | 33.3 | 24.5 | 17.7 |

Higher ΔE* values denote better cleaning.
Activator 1 = Manganese-2-ethylhexanoate salt [CAS# 15956-58-8]; 2 = Manganese bis(2-ethylhexanoate) [CAS # 13434-24-7]; 3 = Tartaric acid, manganese(2+) salt [CAS # 22438-86-4]; 4 = Manganese bis(4-cyclohexylbutyrate) [CAS # 35542-88-2]; 5 = N,N,N′,N′-tetraacetylethylenediamine (TAED).

TABLE 2
Cleaning experiments using six stains per Terg-o-tometer well.

| | | | | | Average ΔE* | | | | | |
|---|---|---|---|---|---|---|---|---|---|---|
| | | | | | | | BC3 | 10BB | CS12 | CS3 |
| | | | [H2O2] | [Activator], | CN17 | BC2 | Tea, Low | Black- | Black | Wine, |
| Entry | Type | Activator | ppm | mol/L | Blank | Coffee | Temperature | berry | Currant | Aged |
| 7 | Carboxylate | 1 | 185 | 1.0E−04 | −0.4 | 2.6 | 6.6 | 21.1 | 32.2 | 14.9 |
| 8 | Carboxylate | 2 | 185 | 1.0E−04 | −0.4 | 2.2 | 5.1 | 21.4 | 30.5 | 14.5 |
| 9 | Carboxylate | 4 | 185 | 1.0E−04 | −0.3 | 2.6 | 6.2 | 21.3 | 31.5 | 14.4 |
| 10 | Carboxylate | 3 | 185 | 1.0E−04 | −0.2 | 3.1 | 8.0 | 21.4 | 33.0 | 16.0 |
| 11 | Reference | 5 | 185 | 5.7E−4 | −0.3 | 2.9 | 6.9 | 21.9 | 24.1 | 16.3 |
| 12 | Reference | None | 185 | 0 | −0.3 | 1.6 | 5.3 | 21.0 | 30.1 | 14.0 |

Higher ΔE* values denote better cleaning.
Activator 1 = Manganese-2-ethylhexanoate salt [CAS# 15956-58-8]; 2 = Manganese bis(2-ethylhexanoate) [CAS # 13434-24-7]; 3 = Tartaric acid, manganese(2+) salt [CAS # 22438-86-4]; 4 = Manganese bis(4-cyclohexylbutyrate) [CAS # 35542-88-2]; 5 = N,N,N′,N′-tetraacetylethylenediamine (TAED).

For testing with nine stains (Table 1), the results may be summarized as follows: the activators of this invention (Entries 1-3) provide superior cleaning to that of the analogous system lacking activator (Entry 6) for many of the stains tested, including BC2 Coffee, BC3 Low Temperature Tea, EMPA167 Tea, CS12 Black Currant, CS15 Blueberry, CS103 Single Soiled Wine (Activator 3), and CS3 Aged Wine (Activators 1 & 3). Several of the activators of this invention provide cleaning performance equivalent or superior to that of the commercial organic activator TAED (Activator 5): Activators 1 & 3 provide equivalent performance to or outperform TAED on BC3 Low Temperature Tea, EMPA167 Tea, CS12 Black Currant, and CS 15 Blueberry; Activator 2 provides equivalent performance to or outperforms TAED on 10BB Blackberry and CS15 Blueberry.

For testing with six stains (Table 2), the results may be summarized as follows: the activators of this invention (Entries 7-10) provide superior cleaning to that of the analogous system lacking activator (Entry 12) for many of the stains tested, including BC2 Coffee, BC3 Low Temperature Tea (Activators 1,3, and 4), 10BB Blackberry, CS12 Black Currant, and CS3 Aged Wine. Several of the activators of this invention provide cleaning performance equivalent or superior to that of the commercial organic activator TAED (Activator 5): Activators 1, 2, and 4 provide equivalent performance to or outperform TAED on CS 12 Black Currant; Activator 3 provides equivalent performance to or outperforms TAED on BC2 Coffee, BC3 Low Temperature Tea, and CS12 Black Currant.

Notable in these comparisons is that the reference TAED system was used at significantly higher concentration (5.7×10⁴ molar) than were the activators of this invention.

1. A composition comprising at least one peroxy compound and an amount of at least one manganese carboxylate activator effective to activate the peroxy compound, wherein the manganese carboxylate activator is comprised of manganese and at least one carboxylate group selected from the group consisting of branched chain carboxylate groups, tartrate, and combinations thereof.

2. The composition of claim 1, wherein the peroxy compound is hydrogen peroxide.

3. The composition of claim 1, wherein the peroxy compound is selected from the group consisting of urea peroxide, organic hydroperoxides, alkali metal peroxides, perborates, percarbonates, perphosphates, persulphates, peroxyacids and their salts and the like and combinations thereof.

4. The composition of claim 1, wherein the at least one carboxylate group includes at least one branched chain carboxylate group.

5. The composition of claim 1, wherein the at least one carboxylate group includes a C3-C12 branched chain carboxylate group.

6. The composition of claim 1, wherein the at least one carboxylate group includes a C6-C10 branched chain carboxylate group.

7. The composition of claim 1, wherein the at least one carboxylate group includes an alicyclic carboxylate group.

8. The composition of claim 1, wherein the at least one carboxylate group includes at least one carboxylate group selected from the group consisting of 2-ethylbutanoate, 2-methylpentanoate, 4-methylpentanoate, 2,2,3-trimethylbutanoate, 2,2-dimethylpentanoate, 2-methyl-hexanoate, 2-ethyl-4-methylpentanoate, 2-ethylhexanoate, 2,24,4-tetramethylpentanoate, 2-propyl-4-methylpentanoate, 3,5,5-trimethylhexanoate, 4-ethyl-5-methylhexanoate, 4-ethyl-5,5-dimethylhexanoate 4-ethyl-5-methylheptanoate, 2-propylheptanoate, cyclohexanecarboxylate, cyclohexaneacetate, cyclohexanepropionate, cyclohexanebutyrate, cyclohexanepentoate, cyclohexanehexanoate and combinations thereof.

9. The composition of claim 1, wherein the manganese is Mn(II) or Mn(III).

10. The composition of claim 1, wherein the at least one carboxylate group includes tartrate.

11. The composition of claim 1, wherein the manganese carboxylate activator is selected from the group consisting of Mn(II) tartrate, Mn(II) bis(2-ethylhexanoate), Mn-2-ethylhexanoate salt, Mn(II) bis(cyclohexanebutyrate), and combinations thereof.

12. The composition of claim 1, additionally comprising at least one auxiliary ingredient selected from the group consisting of surfactants, builders, chelating agents, dye transfer inhibiting agents, dispersants, enzymes, enzyme stabilizers, bleach activators (in addition to the manganese carboxylate), polymeric dispensing agents, brighteners, suds suppressors, dyes, anti-corrosion agents, tarnish inhibitors, perfumes, fabric softeners, carriers, hydrotropes, processing aids, solvents, and pigments.

13. The composition of claim 1, additionally comprising one or more catalysts activators and/or boosters other than the manganese carboxylate activator.

14. A method of making a composition, comprising combining at least one peroxy compound and an amount of at least one manganese carboxylate activator effective to activate the peroxy compound, wherein the manganese carboxylate activator is comprised of manganese and at least one carboxylate group selected from the group consisting of branched chain carboxylate groups, tartrate, and combinations thereof.

15. A composition prepared by the method of claim 14.

16. A method of bleaching a substrate, comprising contacting the substrate with a bleaching composition in accordance with claim 1.

17. The method of claim 16, wherein the substrate has a surface.

18. The method of claim 16, wherein the substrate is a fabric surface.

19. The method of claim 16, wherein the substrate is wood pulp or non-wood pulp or paper.

20. The method of claim 16, wherein the manganese carboxylate activator has been formed in situ.

21. The method of claim 16, wherein the bleaching composition has been formed by combining a first liquid solution comprised of peroxy compound and a second liquid solution comprised of manganese carboxylate activator.

22. The method of claim 21, wherein the first liquid solution and the second liquid solution were maintained in separate chambers of a dispensing apparatus prior to being combined.

23. A method of activating a peroxy compound, comprising combining the peroxy compound with at least one manganese carboxylate activator, wherein the manganese carboxylate activator is comprised of manganese and at least one carboxylate group selected from the group consisting of branched chain carboxylate groups, tartrate, and combinations thereof.
